(19) United States
(12) Patent Application Publication
(10) Pub. No.: US 2011/0168762 A1
(43) Pub. Date: Jul. 14, 2011

(54) SOLDERING IRON TIP

(75) Inventors: Shao Hsuan Chang, Taipei (TW); Ching Shun Chen, Taipei (TW); Wen Chi Chen, Taipei (TW)

(73) Assignee: INVENTEC CORPORATION

(21) Appl. No.: 12/687,534

(22) Filed: Jan. 14, 2010

(51) Int. Cl. B23K 3/02; B23K 3/06

(52) U.S. Cl. 228/41

(57) ABSTRACT

A soldering iron tip is used for heating a solder bar during a soldering operation so as to solder a workpiece. An end surface of the soldering iron tip has a guide hole, and the guide hole forms a channel in the soldering iron tip. Meanwhile, a side surface of the soldering iron tip has a through hole in communication with the channel. When the soldering operation is performed, relative positions of the guide hole and the workpiece overlap each other. After the solder bar is made to pass through the through hole and heated inside the channel, the molten solder bar flows along the channel to reach the workpiece via the guide hole, thereby completing the soldering operation.

### BACKGROUND OF THE INVENTION

1. Field of Invention

The present invention relates to a soldering iron tip, and more particularly to a soldering iron tip capable of wrapping a molten solder bar during a soldering operation.

2. Related Art

In the electronic industry, electric soldering irons have been widely applied in soldering operations of various electronic elements. An electric soldering iron generally includes a handle, a shell, and a soldering iron tip. Two ends of the shell are respectively connected to the handle and the soldering iron tip. An electric wire is disposed at one end of the handle opposite to the shell, and is connected to a heater. The heater supplies electric energy to the shell, and then the coils in the shell convert the electric energy into heat energy. Then, the heat energy is further conducted to the soldering iron tip, so as to heat up the soldering iron tip to a temperature capable of melting a metal solder bar (for example, a copper solder bar, a tin solder wire, or a silver solder bar), thereby performing a soldering operation on electronic elements.

In order to carry out the soldering operation conveniently, considering the structural design of the soldering iron tip, one end of the soldering iron tip contacting the solder joint is generally designed into a tapered heating end, a linear heating end, or a bevel-cutter-blade heating end, so as to cater to different soldering positions. For example, when a solder joint range between connecting circuits and electronic elements on a circuit board is rather small, a soldering iron tip having a tapered heating end is selected to solder the solder joint; or when the solder joint range is quite large, a soldering iron tip having a linear heating end or bevel-cutter-blade heating end is selected to solder the solder joint.

However, during the soldering operation, firstly, the soldering iron tip is used to contact the solder joint, so as to preheat the solder joint. Then, one end of the metal solder bar is inserted into a gap between the solder joint and the soldering iron tip, and contacts the tapered, linear, or bevel-cutter-blade heating end of the soldering iron tip, such that the soldering iron tip heats and melts the metal solder bar, and the metal solder bar becomes a molten solder to flow to the solder joint, thereby completing the soldering operation. In this process, since the position of the soldering iron tip contacting the metal solder bar is exposed to the external environment, the heat loss easily occurs due to the convection with the outside air, and as a result, the soldering iron tip cannot uniformly heat the metal solder bar, thereby affecting the soldering quality and hindering the soldering operation.

Moreover, the structural design of the conventional soldering iron tip cannot restrict the flowing direction of the molten solder. After the metal solder bar is heated and melted by the soldering iron tip, the molten solder diffuses on the solder joint and flows to other areas or electronic elements adjacent to the solder joint on the circuit board, thereby damaging the circuits on the circuit board or resulting in short circuit of other electronic elements due to being contaminated by the solder. Therefore, when the conventional soldering iron tip is used, the circuit board or the electronic element adjacent to the solder joint is easily damaged due to the inexperience or carelessness of the operator, thereby resulting in the risks of rework and repairing during the manufacturing process of the circuit board.

In view of the above deficiencies of the conventional soldering iron tip, it is necessary to improve the structure of the soldering iron tip, so as to improve the working efficiency, ensure the soldering quality of the electronic elements, and reduce the risks of rework and repairing.

### SUMMARY OF THE INVENTION

Accordingly, the present invention is a soldering iron tip, which is applicable to solve the problem that when the conventional soldering iron tip is used to perform a soldering operation, since a contact surface between the soldering iron tip and a metal solder bar is exposed to the outside air, heat loss easily occurs, thereby affecting the soldering quality, and solve the problem that after the metal solder bar is heated and melted by the soldering iron tip, the molten solder easily diffuses to areas outside the solder joint, thereby damaging or resulting in short circuit of the areas and electronic elements adjacent to the solder joint due to being contaminated by the solder.

The present invention provides a soldering iron tip, which is applicable to heat a solder bar to perform a soldering operation on a workpiece. An end surface of the soldering iron tip has a guide hole, and the guide hole is opened along an axial direction of the soldering iron tip and forms a channel in the soldering iron tip. A side surface of the soldering iron tip has a through hole, and the through hole is opened along a radial direction of the soldering iron tip and is in communication with the channel. When the soldering operation is performed, relative positions of the guide hole and the workpiece overlap each other. The solder bar is made to pass through the through hole and heated and melted, such that the molten solder bar flows along the channel to reach the workpiece via the guide hole.

The present invention further provides a soldering iron tip, which is applicable to heat a solder bar to perform a soldering operation on a workpiece. An end surface of the soldering iron tip has a guide hole, and the guide hole is opened along an axial direction of the soldering iron tip and forms a channel in the soldering iron tip. The channel is exposed out of a side surface of the soldering iron tip. When the soldering operation is performed, relative positions of the guide hole and the workpiece overlap each other, and the solder bar is inserted into the channel and heated and melted, such that the molten solder bar flows along the channel to reach the workpiece via the guide hole.

In the soldering iron tip of the present invention, since the guide hole and the channel are designed to be in communication with each other, the molten solder bar is restricted by the channel and thus confined to the workpiece, thereby preventing the molten solder bar from flowing to other areas outside the workpiece due to the diffusion effects thereof. Meanwhile, during the soldering operation, since one end of the solder bar contacting the soldering iron tip is wrapped in the channel, the molten solder bar is maintained in a stable high-temperature environment, thereby preventing the molten solder bar from being in direct contact with the outside air to result in the non-uniform heating problem.

### BRIEF DESCRIPTION OF THE DRAWINGS

The present invention will become more fully understood from the detailed description given herein below for illustration only, and thus is not limitative of the present invention, and wherein:

FIG. 1 is a schematic assembled view of a first embodiment of the present invention;

FIG. 2 is a schematic partially enlarged view of FIG. 1;

FIGS. 3A and 3B are schematic views showing operations of the first embodiment of the present invention;

FIG. 4 is a schematic partially enlarged view of a soldering iron tip according to a second embodiment of the present invention;

FIG. 5 is a schematic view showing operations of the second embodiment of the present invention;

FIG. 6 is a schematic structural view of the soldering iron tip with an end surface disposed thereon in an inclined manner according to the second embodiment of the present invention;

FIG. 7 is a schematic view showing operations of the soldering iron tip with the end surface disposed thereon in an inclined manner according to the second embodiment of the present invention;

FIG. 8 is a schematic assembled view of a third embodiment of the present invention;

FIG. 9 is a schematic partially enlarged view of FIG. 8;

FIG. 10 is a schematic view showing operations of the third embodiment of the present invention; and

FIG. 11 is a schematic structural view of a V-shaped channel according to the third embodiment of the present invention.

### DETAILED DESCRIPTION OF THE INVENTION

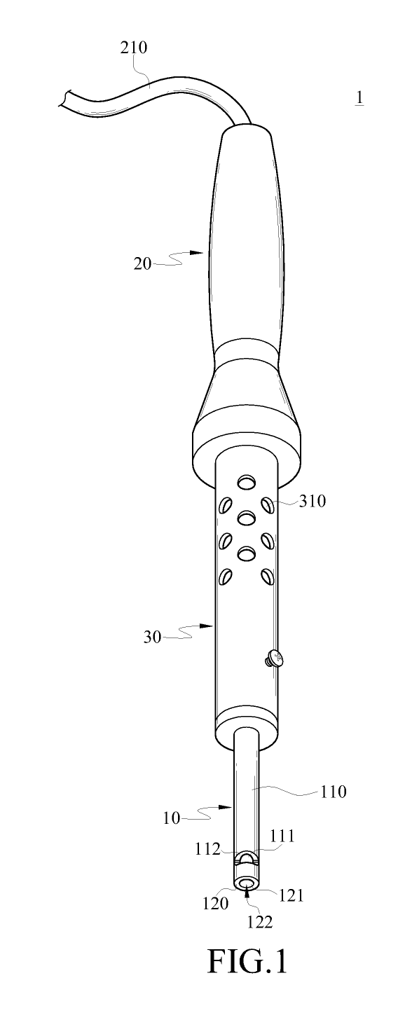

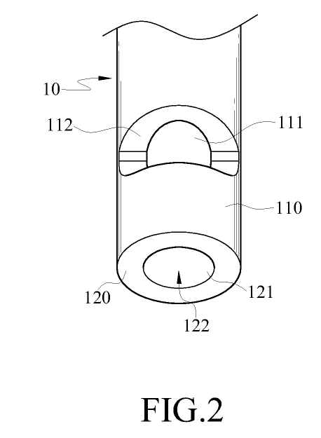

Referring to FIGS. 1 and 2, a soldering iron tip 10 provided in a first embodiment of the present invention is disposed on an electric soldering iron 1. Besides the soldering iron tip 10, the electric soldering iron 1 further comprises a handle 20 and a metal shell 30. One end of the handle 20 is disposed with an electric wire 210, and the other end of the handle 20 is connected to the metal shell 30. The electric wire 210 is configured to be connected to a heater (not shown), and used for transferring electric energy supplied by the heater to the metal shell 30. A plurality of heat-dissipation holes 310 is opened in the metal shell 30, and a plurality of coils (not shown) is accommodated in the metal shell 30 and used for converting the electric energy transferred to the metal shell 30 into heat energy.

One end of the soldering iron tip 10 is inserted into the metal shell 30, and the soldering iron tip 10 has a side surface 110. The side surface 110 extends from the end of the soldering iron tip 10 inserted into the metal shell 30 towards the other end of the soldering iron tip 10 opposite to the metal shell 30. The other end of the soldering iron tip 10 opposite to the metal shell 30 has an end surface 120. The side surface 110 of the soldering iron tip 10 surrounds the edge of the end surface 120, that is to say, the side surface 110 is connected to the end surface 120 in an approximately perpendicular manner. The end surface 120 has a guide hole 121, and the guide hole 121 is opened in the end surface 120 along an axial direction of the soldering iron tip 10. The axial direction means that the guide hole 121 extends from the end surface 120 of the soldering iron tip 10 towards the end of the soldering iron tip 10 inserted into the metal shell 30, and forms a channel 122 at the other end of the soldering iron tip 10 opposite to the metal shell 30.

In addition, the side surface 110 of the soldering iron tip 10 has a through hole 111. The through hole 111 is opened at a proper position on the side surface 110 adjacent to the end surface 120, and the through hole 111 is opened in the side surface 110 along a radial direction of the soldering iron tip 10. The radial direction means that the through hole 111 extends from the side surface 110 towards the channel 122 and traverses the side surface 110, such that the through hole 111 is in communication with the channel 122. One side edge of the side surface 110 adjacent to the through hole 111 has a guide chamfer 112. The guide chamfer 112 is disposed to be inclined from the side of the side surface 110 adjacent to the through hole 111 towards the guide hole 121 of the end surface 120.

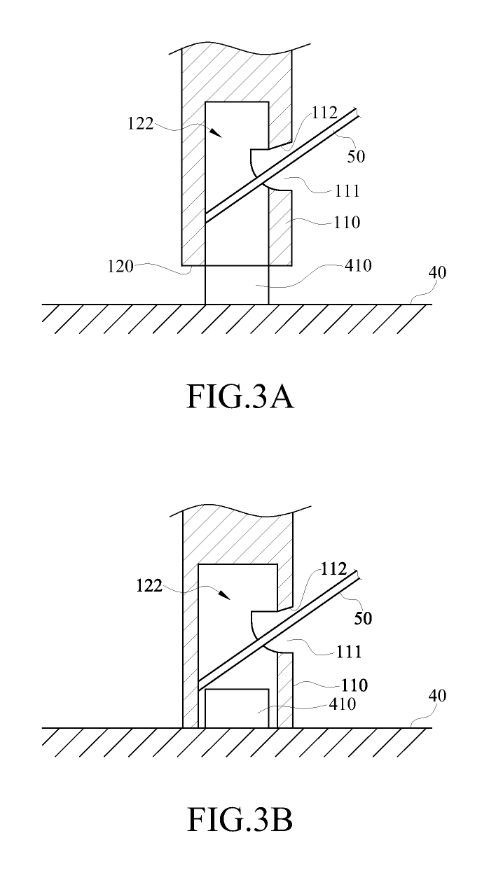

Referring to FIGS. 1 to 3B, when the soldering iron tip 10 provided in this embodiment is applied to a soldering operation, the end surface 120 of the soldering iron tip 10 is made to cover a surface of a workpiece 410 on a substrate 40 (for example, a surface of an electronic element disposed on a circuit board), such that relative positions of the guide hole 121 and the workpiece 410 overlap each other, and the guide hole 121 of the end surface 120 covers the entire workpiece 410 (as shown in FIG. 3A), or the workpiece 410 is received within the channel 122 of the soldering iron tip 10 (as shown in FIG. 3B). Then, under the guide of the guide chamfer 112 of the soldering iron tip 10, a metal solder bar 50 (for example, a tin solder wire or a copper solder bar) is inserted into the channel 122 through the through hole 111 of the soldering iron tip 10. Here, since the through hole 111 is provided to enable the solder bar 50 to be inserted into the channel 122, an aperture of the through hole 111 and a width of the channel 122 need to be designed to be at least slightly greater than a diameter of the solder bar 50.

After the solder bar 50 is inserted into the channel 122, one end of the solder bar 50 located in the channel 122 is heated by the soldering iron tip 10 to form a molten solder (not shown). The molten solder is blocked and confined in the channel 122, and flows along the channel 122 to reach the workpiece 410 via the guide hole 121, thereby completing the soldering operation.

Since the solder bar 50 is heated and melted within the channel 122 of the soldering iron tip 10, and the molten solder formed by the solder bar 50 is wrapped in the channel 122, the molten solder is maintained at a certain heating temperature in the channel 122, thereby effectively solving the problem that the soldering quality is degraded due to the rapid heat loss after the solder bar 50 is heated and melted. Moreover, since the molten solder is blocked and confined in the channel, the molten solder formed by the solder bar 50 is prevented from flowing to other areas adjacent to the workpiece 410, so as to ensure that circuits or other workpieces (not shown) disposed on the substrate 40 are not contaminated by the solder, thereby reducing the risks of reworking the workpiece and damaging the substrate.

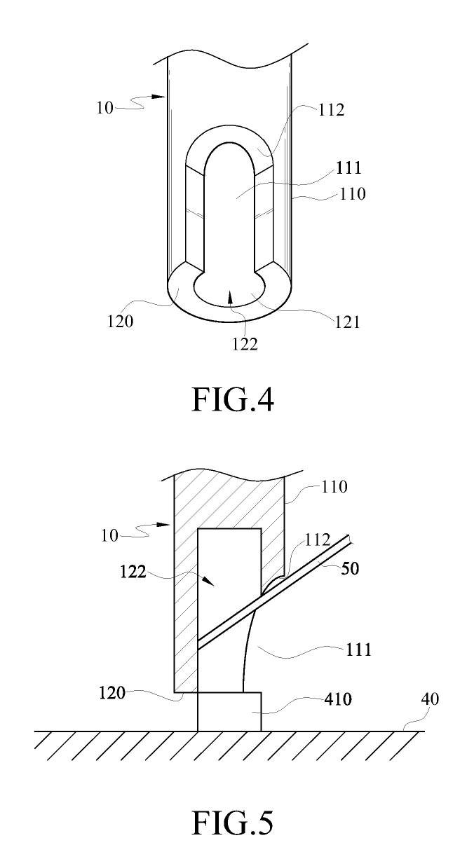

FIG. 4 is a schematic partially enlarged view of a soldering iron tip according to a second embodiment of the present invention. Referring to FIG. 4, in the soldering iron tip 10 provided in the second embodiment of the present invention, the through hole 111 opened in the side surface 110 of the soldering iron tip 10 extends to the end surface 120, such that the through hole 111 is connected to the guide hole 121 of the end surface 120, so as to cater to the use of solder bars 50 with different diameters or shapes. Meanwhile, one side edge of the side surface 110 adjacent to the through hole 111 has a guide chamfer 112. The guide chamfer 112 is located at a position on one side of the side surface 110 connected to the through hole 111 far away from the guide hole 121. The guide chamfer 112 is disposed to be inclined from the side surface 110 towards the guide hole 121.

Referring to FIGS. 4 and 5, when the soldering iron tip 10 provided in this embodiment is applied to a soldering operation, the end surface 120 of the soldering iron tip 10 is made to cover a surface of a workpiece 410 on a substrate 40 (for example, a surface of an electronic element disposed on a circuit board), such that relative positions of the guide hole 121 and the workpiece 410 overlap each other, and the guide hole 121 of the end surface 120 covers the entire workpiece 410, or the workpiece 410 is received within the channel 122 of the soldering iron tip 10 (not shown). Then, a metal solder bar 50 (for example, a tin solder wire or a copper solder bar) is inserted into the channel 122 through the through hole 111 of the soldering iron tip 10. At this time, the solder bar 50 enters the channel 122 under the guide of the guide chamfer 112 of the soldering iron tip 10, and the solder bar 50 is heated by the soldering iron tip 10 to form a molten solder (not shown).

Since the solder bar 50 inserted into the channel 122 is wrapped by the soldering iron tip 10, the molten solder formed by the solder bar 50 is wrapped and blocked by the soldering iron tip 10 and confined in the channel 122, and flows along the channel 122 to reach the workpiece 410 via the guide hole 121, thereby preventing the molten solder from flowing to other areas on the substrate 40 adjacent to the workpiece 410.

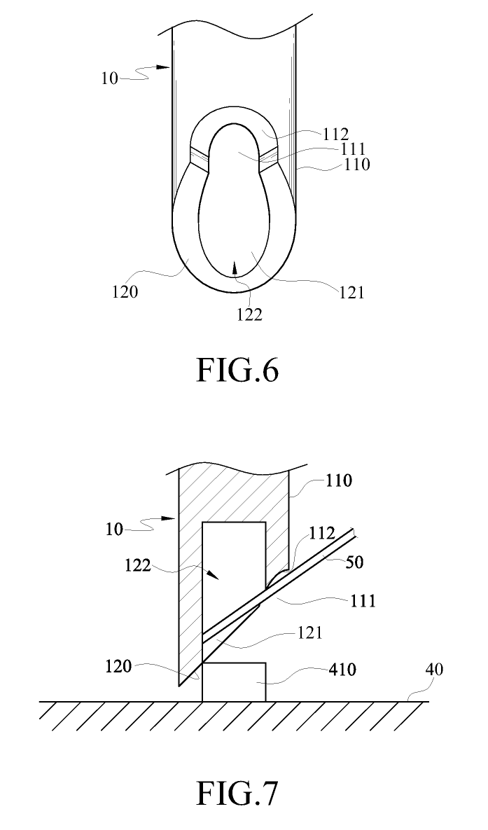

Moreover, as shown in FIGS. 6 and 7, in the second embodiment, the end surface 120 of the soldering iron tip 10 may also be disposed on the soldering iron tip 10 in an inclined manner, that is, the end surface 120 forms an angle of smaller than or larger than 90 degrees with respect to the side surface 110, instead of being perpendicular to the side surface 110. Therefore, the solder bar 50 is inserted into the channel 122 through the through hole 111 or the guide hole 121. In addition, the molten solder formed by the solder bar 50 is also wrapped and blocked by the soldering iron tip 10 and confined to the area of the workpiece 410 covered by the channel 122, thereby preventing the molten solder from flowing to areas outside the workpiece 410.

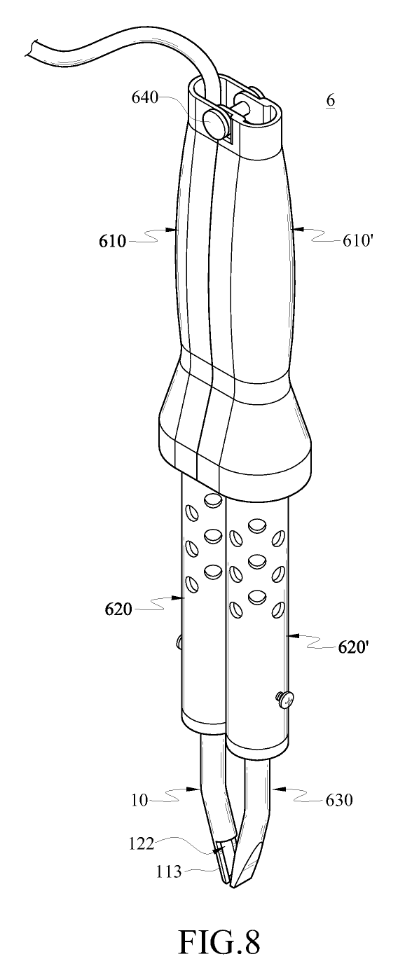

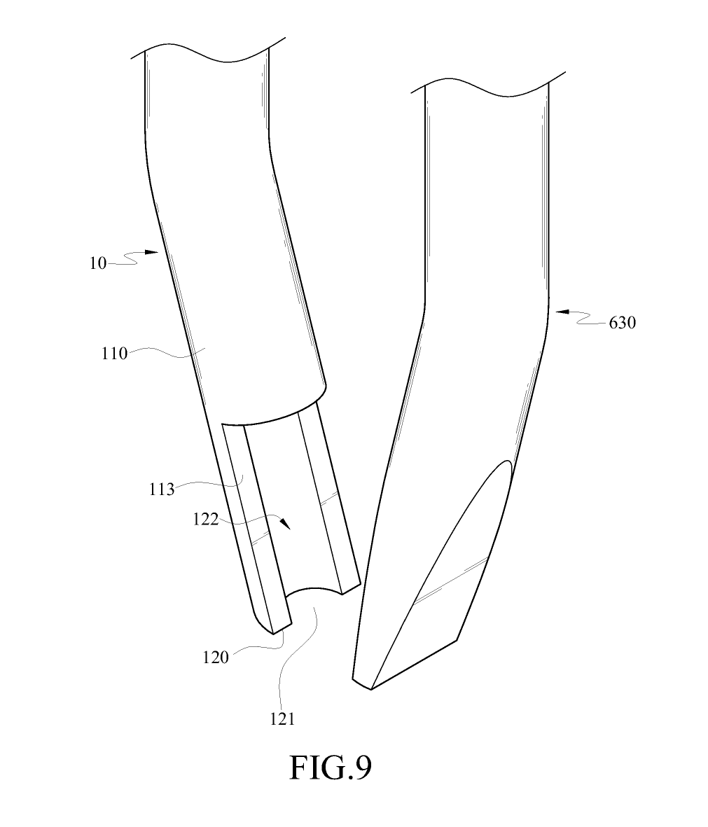

Referring to FIGS. 8 and 9, the soldering iron tip 10 provided in a third embodiment of the present invention is applied in a hot tweezer-type electric soldering iron 6. The hot tweezer-type electric soldering iron 6 comprises two handles 610, 610′, two metal shells 620, 620′, two soldering iron tips 10, 630, and a pivot 640. Two ends of the metal shell 620 are respectively connected to the handle 610 and the soldering iron tip 10 provided in the third embodiment of the present invention, and two ends of the metal shell 620′ are respectively connected to the handle 610′ and the bevel-cutter-blade-type (or flat-type) soldering iron tip 630. The two handles 610 and 610′ are connected by the pivot 640, so that the two handles 610 and 610′ can rotate relative to each other around the pivot 640, so as to drive the two soldering iron tips 10 and 630 to join together or separate from each other.

It should be understood that, in the third embodiment of the present invention, the configurations of the two soldering iron tips may comprise, but not limited to, the combination of the soldering iron tip 10 provided in the third embodiment of the present invention and the ordinary bevel-cutter-blade-type (or flat-type) soldering iron tip 630. Therefore, in the third embodiment of the present invention, the two soldering iron tips disposed on the hot tweezer-type electric soldering iron may both adopt the soldering iron tip 10 provided in the third embodiment of the present invention. In this embodiment, the combination of the soldering iron tip 10 provided in the third embodiment of the present invention and the ordinary bevel-cutter-blade-type (or flat-type) soldering iron tip 630 is merely taken as an example for illustration, but the present invention is not limited thereto.

One end of the soldering iron tip 10 provided in the third embodiment of the present invention is inserted into the metal shell 620, and the soldering iron tip 10 has a side surface 110. The side surface 110 extends from the end of the soldering iron tip 10 inserted into the metal shell 620 towards the other end of the soldering iron tip 10 opposite to the metal shell 620. Meanwhile, the other end of the soldering iron tip 10 opposite to the metal shell 620 has an end surface 120. The side surface 110 of the soldering iron tip 10 surrounds the edge of the end surface 120, so that the side surface 110 is connected to the end surface 120 in an approximately perpendicular manner. A cutting plane 113 connected to the end surface 120 is formed at a position of the side surface 110 adjacent to the end surface 120.

The end surface 120 has a guide hole 121, and the guide hole 121 is opened in the end surface 120 along an axial direction of the soldering iron tip 10. The axial direction means that the guide hole 121 extends from the end surface 120 of the soldering iron tip 10 towards the end of the soldering iron tip 10 inserted into the metal shell 620, and forms a channel 122 at the other end of the soldering iron tip 10 opposite to the metal shell 620, in which the channel 122 is exposed out of the cutting plane 113.

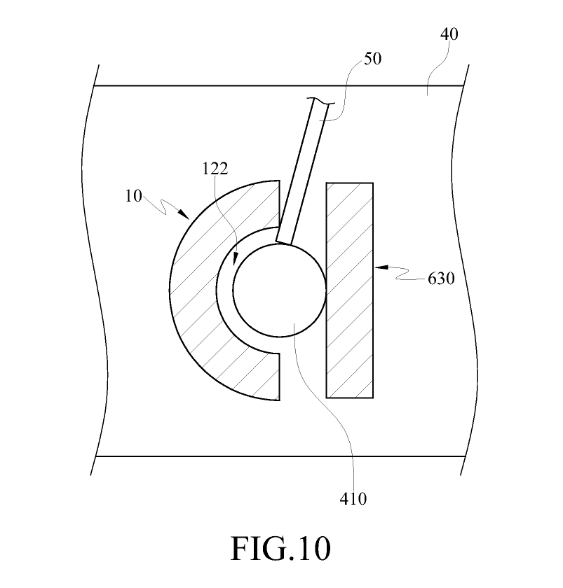

Referring to FIGS. 8 to 10, when the hot tweezer-type electric soldering iron 6 provided in the third embodiment of the present invention is applied to a soldering operation, the bevel-cutter-blade-type (or flat-type) soldering iron tip 630 is pressed against one side of a workpiece, and then the soldering iron tip 10 is moved to approach the other side of the workpiece opposite to the bevel-cutter-blade-type (or flat-type) soldering iron tip 630. At this time, relative positions of the guide hole 121 of the soldering iron tip 10 and the workpiece 410 overlap each other, and one side edge (that is, a position to be soldered) of the workpiece 410 is received within the channel 122 of the soldering iron tip 10 (as shown in FIG. 10). Then, a metal solder bar 50 (for example, a tin solder wire or a copper solder bar) is inserted into the channel 122 through a gap between the two soldering iron tips 10 and 630. Since the gap between the two soldering iron tips 10 and 630 and the channel 122 are provided for enabling one end of the solder bar 50 to be inserted and accommodated therein, the width of the gap and the channel 122 needs to be at least slightly greater than a diameter of the solder bar 50.

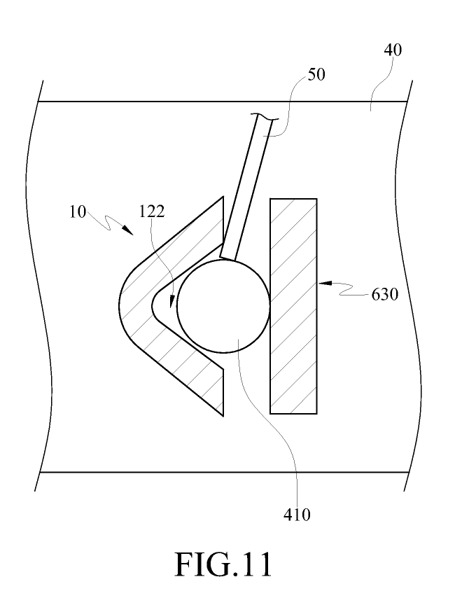

After the solder bar 50 is inserted into the channel 122, one end of the solder bar 50 located in the channel 122 is heated by the soldering iron tip 10 to form a molten solder (not shown). The molten solder is blocked and confined in the channel 122, and flows along the channel 122 and the guide hole 121 to reach the workpiece 410, thereby completing the soldering operation. The channel 122 of the soldering iron tip 10 is not limited to the arc-shaped structure, but may also be designed into a V-shaped (or triangular) structure as shown in FIG. 11. In this case, the molten solder is similarly blocked and confined in the channel 122, and thus restricted from freely flowing on the workpiece 410.

Since the solder bar 50 is heated and melted in the channel 122 of the soldering iron tip 10, and the molten solder formed by the solder bar 50 is wrapped in the channel 122, the problem that the soldering quality is degraded due to the rapid heat loss after the solder bar 50 is heated and melted is effectively solved, and the molten solder formed by the solder bar 50 is prevented from flowing to other areas adjacent to the workpiece 410, thereby reducing the risks of reworking the workpiece and damaging the substrate due to being contaminated by the solder.

1. A soldering iron tip, applicable to heat a solder bar to perform a soldering operation on a workpiece, wherein an end surface of the soldering iron tip has a guide hole, the guide hole is opened along an axial direction of the soldering iron tip and forms a channel, a side surface of the soldering iron tip has a through hole, the through hole is opened along a radial direction of the soldering iron tip and is in communication with the channel, relative positions of the guide hole and the workpiece overlap each other, and the solder bar is made to pass through the through hole and heated and melted, and flows along the channel to reach the workpiece via the guide hole.

2. The soldering iron tip according to claim 1, wherein one side of the side surface adjacent to the through hole further has a guide chamfer, and the guide chamfer is disposed to be inclined from the side of the side surface adjacent to the through hole towards a direction of the guide hole.

3. The soldering iron tip according to claim 1, wherein the through hole further extends from the side surface to the end surface, and is connected to the guide hole.

4. The soldering iron tip according to claim 1, wherein an aperture of the through hole matches with a diameter of the solder bar.

5. A soldering iron tip, applicable to heat a solder bar to perform a soldering operation on a workpiece, wherein an end surface of the soldering iron tip has a guide hole, the guide hole is opened along an axial direction of the soldering iron tip and forms a channel, the channel is exposed out of a side surface of the soldering iron tip, relative positions of the guide hole and the workpiece overlap each other, and the solder bar is inserted into the channel and heated and melted, and flows along the guide hole to reach the workpiece.

6. The soldering iron tip according to claim 5, wherein a position of the side surface adjacent to the end surface has a cutting plane.

7. The soldering iron tip according to claim 5, wherein a diameter of the channel matches with that of the solder bar.
